(19) United States
(12) Patent Application Publication
(10) Pub. No.: US 2026/0296323 A1
(43) Pub. Date: Oct. 1, 2026

(54) VEHICLE WITH A CENTRE CONSOLE

(71) Applicant: MERCEDES-BENZ GROUP AG, Stuttgart (DE)

(72) Inventors: Benno STAMP, Stuttgart (DE); Valentin MAIER, Ispringen (DE)

(21) Appl. No.: 19/476,013

(22) PCT Filed: Apr. 5, 2024
(86) PCT No.: PCT/EP2024/059281

§ 371 Date: Oct. 16, 2025

(30) Foreign Application Priority Data
Apr. 17, 2023 (DE) 10 2023 001 514.8

(51) Int. Cl. B60R 7/04; B60R 11/00

(52) U.S. Cl. CPC B60R 7/04; B60R 11/00; B60R 2011/0007; B60R 2011/0071

(57) ABSTRACT

A vehicle has a center console between the front seats. The center console has a bottom part and a top part arranged on the bottom part. The top part is longitudinally displaceable in the vehicle longitudinal direction (x direction). A fastener connected to the center console is provided for securing cargo stored in a storage area in the bottom part of the center console.

### BACKGROUND AND SUMMARY OF THE INVENTION Exemplary embodiments of the invention relate to a vehicle with a center console.

In many vehicle models, the vehicle interior is really quite spacious, meaning that versatile options for storing items can be provided therein.

This also applies, for example, to battery electric vehicles (BEVs) operated by means of a traction battery, in which a large storage surface can be realized in the region of the center console because there is no cardan shaft. However, the cargo situated on this storage surface, such as relatively large items, for example, may sometimes impair driving safety, particularly when certain driving maneuvers are performed while the vehicle is travelling.

A device for a vehicle interior, comprising a seat designed to move in a direction of travel and a console coupled to the movable seat, is known from DE 10 2017 129 147 A1 . The console can include: a collapsible section that collapses if a section of the console moves in the direction of travel, a stepped connection point for connection to the movable seat, a rear pull-out part with a hinged door to enable passengers to access a rear region, and an extendable holder for a mobile handheld computer.

DE 10 2012 010 666 A1 proposes an armrest arrangement for a motor vehicle, having an armrest, wherein the armrest has a receptacle device that can be displaced in a displacement direction between a retracted position and an extended position, and having an armrest carrier on which the armrest is arranged, wherein the armrest can be displaced relative to the armrest carrier between a start position and an end position in an adjusting direction that is in the same direction as the displacement direction.

CN 2 17 396 384 U proposes a door protection plate assembly for an automobile. The door protection plate assembly consists of a protection plate body and a restricting belt, wherein a map pocket is arranged on the inner side face of the main body of the protection plate. The restricting belt is provided with a fastening part and a connecting part, wherein the fastening part is arranged securely fixed to a motherboard and is in front of or behind the map pocket. The restricting belt has a rest state, in which the fastening part and the connecting part are both in front of or behind the map pouch, and a use state in which the connecting part and the fastening part are in each case secured in front of and behind the map pouch. If the restricting belt is in the use state, the restricting belt can make contact with items and restrict them.

Exemplary embodiments of the invention are directed to a generic vehicle with a center console in which the cargo stored in the area of the center console can easily be secured and in particular in a way that is simple for an operator to handle.

In a (spacious) storage area in the bottom part of the center console, the cargo stored in this storage area is secured according to the invention by a fastener connected to (at least a part of) the center console, thereby preventing undesired movement of the cargo in the storage area.

In particular, the cargo is prevented from slipping in the storage area while the vehicle is travelling, as can occur, for example, due to the vehicle performing a braking maneuver or cornering.

In particular, this also means that in the event of the vehicle being involved in a crash, the risk of the vehicle occupants being injured by the cargo can be effectively reduced.

The fastener has a belt webbing that can be tensioned between a belt retractor or seatbelt reel and a belt receiver. The belt webbing is fastened in the belt receiver in the extended and tensioned state using a particular arresting mechanism; in particular, the belt webbing is automatically locked with the belt receiver when it is inserted into the belt receiver.

The activation of the fastener, i.e., the triggering or release of the belt webbing from the belt retractor, can be effected either by manual actuation by an operator or by means of actuation of a control element.

This control element that can be actuated by an occupant of the motor vehicle is designed, for example, as a push button, toggle switch, or pivot switch, on actuation of which the belt webbing can be pulled out of the seatbelt reel and can be moved towards the belt receiver.

The belt webbing consists in particular of a textile with polymer fibers, just like seatbelts in a vehicle, or of a link chain with chain links made of metal or with chain links made of metal-coated plastic The belt webbing can be tensioned in the vehicle longitudinal direction (x direction) and thus in a horizontal direction between the belt retractor or seatbelt reel and the belt receiver.

In this case, both the belt retractor and the belt receiver of the fastener can be fastened to the bottom part of the center console spaced apart from and level with one another; in particular, the belt retractor or the belt receiver is attached to the front end of the bottom part of the center console and then the belt receiver or the belt retractor is accordingly attached to the rear end of the bottom part of the center console.

Alternatively, the belt retractor or the belt receiver of the fastener can be fastened to the top part of the center console and then the belt receiver or the belt retractor of the fastener can accordingly be fastened to the vehicle dashboard at the same height.

In a preferred second embodiment of the invention, the belt webbing can be tensioned in the vehicle vertical direction (z direction) and thus in a vertical direction between the belt retractor or seatbelt reel and the belt receiver.

In this case, the belt retractor or the belt receiver of the fastener can be fastened to the top part of the center console and then the belt receiver or the belt retractor of the fastener can accordingly be fastened to the bottom part of the center console at the same longitudinal position.

In an embodiment in which the belt retractor or the belt receiver of the fastener is fastened to the top part of the center console, when the top part of the center console is longitudinally displaced in the vehicle longitudinal direction (x direction), the belt retractor of the fastener fastened thereto or the belt receiver of the fastener fastened thereto is also longitudinally displaced in the vehicle longitudinal direction (x direction) together with the top part of the center console.

In a particular embodiment of the center console, the top part of the center console can be displaced with its front end as far as the dashboard of the vehicle in the event of a longitudinal displacement in the vehicle longitudinal direction (x direction), so that the top part of the center console bears flush against the dashboard of the vehicle.

When the center console is in this position, a closed surface is thus formed for the storage area in the bottom part of the center console.

Advantageously, with the above-presented invention, even bulky cargo situated in the region of the center console can be efficiently and effectively secured easily and cost-effectively.

Further advantages, features and details of the invention will become apparent from the following description of preferred exemplary embodiments and with reference to the drawing.

The features and feature combinations mentioned above in the description and the features and feature combinations mentioned hereinafter in the description of the figures and/or shown on their own in the figures can be used not only in the respectively specified combination, but also in other combinations or in isolation, without departing from the scope of the invention.

### BRIEF DESCRIPTION OF THE DRAWING FIGURES

The figures show:

FIG. 1 A schematic sectional illustration of the longitudinally displaceable center console of a vehicle.

FIG. 2 A schematic sectional illustration of the longitudinally displaceable center console of a vehicle with a first embodiment of the fastener.

FIG. 3 A schematic sectional illustration of the longitudinally displaceable center console of a vehicle with a second embodiment of the fastener.

FIG. 4 A schematic sectional illustration of the longitudinally displaceable center console of a vehicle with a third embodiment of the fastener.

### DETAILED DESCRIPTION

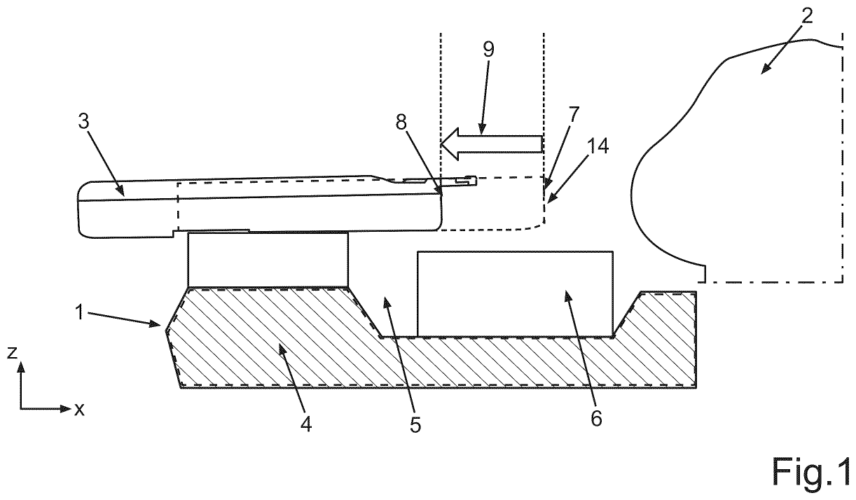

According to FIG. 1, the center console 1 of a vehicle arranged in the region of the front seat of the vehicle has a bottom part 4 and a top part 3 that is arranged on the bottom part 4 and is longitudinally displaceable in the vehicle longitudinal direction (x direction).

This top part 3 of the center console 1 can be longitudinally displaced along the travel path 9 in the vehicle longitudinal direction (x direction), i.e., between a front position 7 and a rear position 8 of the top part 3 of the center console 1. For example, during this longitudinal displacement in the vehicle longitudinal direction (x direction), a maximum travel path 9 of the top part 3 of the center console 1 of between 20 cm and 30 cm is possible.

For example, in one particular design of the center console 3, the top part 3 of the center console 1 can also be displaced along the travel path 9 in the vehicle longitudinal direction (x direction) towards the dashboard 2 of the vehicle, so that the front end 14 of the top part 3 of the center console 1 in this case bears flush against the dashboard 2 of the vehicle.

A spacious storage area 5 formed by appropriately shaping the bottom part 4 of the center console 1 is formed in the bottom part 4 of the center console 1, which storage area can be used to receive or store even bulky cargo 6 with corresponding items to be stored therein.

On its top side, the storage area 5 is covered by the top part 3 of the center console 1, with this coverage of the storage area 5 being configured differently in accordance with the current position of the top part 3 of the center console 1 that is longitudinally displaceable in the vehicle longitudinal direction (x direction) and thus depending on the current position of the front end 14 of the top part 3 of the center console 1.

For example, when a top part 3 of the center console 1 is displaced along the travel path 9 in the vehicle longitudinal direction (x direction) as far as the dashboard 2 of the vehicle, a closed cover for the storage area 5 is formed by the top part 3 of the center console 1.

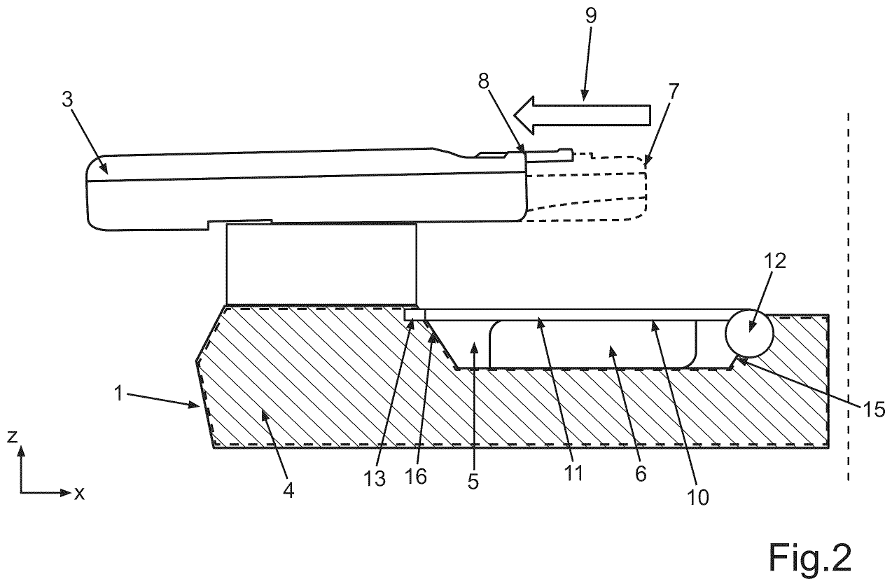

According to FIG. 2, a fastener 10 is provided for securing the cargo 6 situated in the storage area 5.

This fastener 10 has a flexible belt webbing 11 that can be tensioned between a belt retractor or seatbelt reel 12 and a belt receiver 13 and that consists, for example, of a textile with integrated polymer fibers.

According to the exemplary embodiment shown in FIG. 2, the belt retractor or seatbelt reel 12 of the fastener 10 is arranged on the front end 15 of the storage area 5 and the belt receiver 13 of the fastener 10 is arranged on the rear end 16 of the storage area 5 at the same height in the vehicle vertical direction (z direction).

As a result, the flexible belt webbing 11 of the fastener 10, which can be tensioned horizontally between the belt retractor or seatbelt reel 12 and the belt receiver 13 in the vehicle longitudinal direction (x direction), can have a length of between 40 cm and 60 cm, for example.

The cargo 6 situated in the storage area 5 is thus secured on its top side by the belt webbing 11 of the fastener 10 and therefore held securely in the storage area 5 even while the vehicle is travelling.

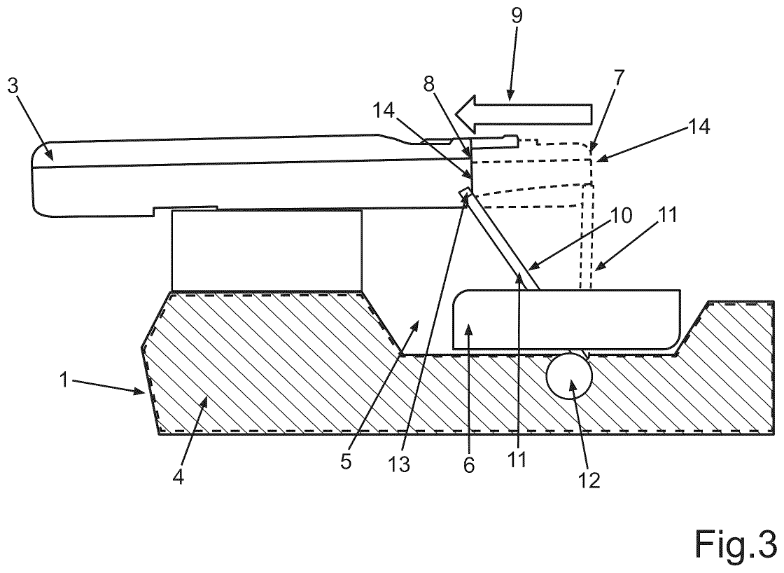

According to FIG. 3, an alternative fastener 10 is provided for securing the cargo 6 situated in the storage area 5.

This fastener 10 also has a flexible belt webbing 11 that can be tensioned between a belt retractor or seatbelt reel 12 and a belt receiver 13 and that consists, for example, of a textile with integrated polymer fibers.

According to the exemplary embodiment shown in FIG. 3, the belt retractor or seatbelt reel 12 of the fastener 10 is attached to the middle of the bottom part 4 of the center console 1 and the belt receiver 13 of the fastener 10 is arranged on the front end 14 of the top part 3 of the center console 1.

As a result, the flexible belt webbing 11 of the fastener 10, which can be tensioned vertically between the belt retractor or seatbelt reel 12 and the belt receiver 13 in the vehicle vertical direction (z direction), can have a length of between 20 cm and 45 cm, for example.

The cargo 6 situated in the storage area 5 is thus secured laterally by the belt webbing 11 of the fastener 10 and therefore held securely in the storage area 5 even while the vehicle is travelling.

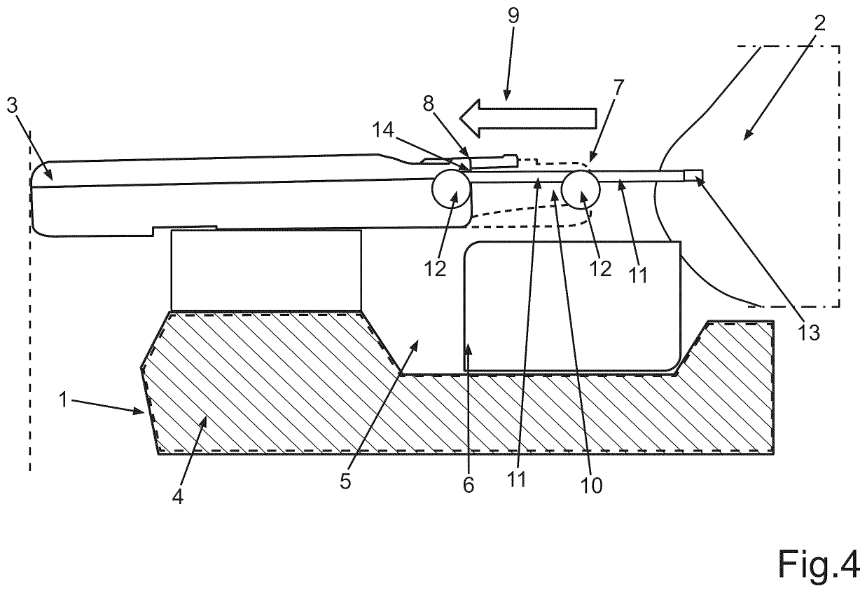

According to FIG. 4, a further alternative fastener 10 is provided for securing the cargo 6 situated in the storage area 5.

This fastener 10 also has a flexible belt webbing 11 that can be tensioned between a belt retractor or seatbelt reel 12 and a belt receiver 13 and that consists, for example, of a textile with integrated polymer fibers.

According to the exemplary embodiment shown in FIG. 4, the belt retractor or seatbelt reel 12 of the fastener 10 is arranged on the front end 14 of the top part 3 of the center console 1 and the belt receiver 13 of the fastener 10 is attached on the dashboard 2 at the same height in the vehicle vertical direction (z direction).

As a result, the flexible belt webbing 11 of the fastener 10, which can be tensioned horizontally between the belt retractor or seatbelt reel 12 and the belt receiver 13 in the vehicle longitudinal direction (x direction), can have a length of between 25 cm and 45 cm, for example.

In this embodiment of the fastener 10 as well, if the top part 3 of the center console 1 is longitudinally displaced horizontally in the vehicle longitudinal direction (x direction), the belt receiver 13 of the fastener 10 arranged on the front end 14 of the top part 3 of the center console 1 is also displaced at the same time in the vehicle longitudinal direction (x direction). Therefore, the belt webbing 11 of the fastener 10 is also displaced in the vehicle longitudinal direction (x direction) and therefore the cargo 6 situated in the storage area 5 is also held securely in the storage area 5 during the longitudinal displacement of the top part 3 of the center console 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A vehicle comprising:
front seats; and
a center console arranged between the front seats, wherein the center console has a bottom part and a top part, wherein the top part is arranged on the bottom part, wherein the top part is longitudinally displaceable in longitudinal direction of the vehicle; and
a fastener connected to the center console and configured to secure cargo stored in a storage area in the bottom part of the center console, wherein the fastener has a belt webbing tensionable between a belt retractor and a belt receiver, wherein the belt webbing is tensionable horizontally, in a longitudinal direction of the vehicle, between the belt retractor and the belt receiver.

10. The vehicle of claim 9, wherein the belt retractor and the belt receiver of the fastener are fastened to the bottom part of the center console.

11. The vehicle of claim 9, wherein the belt retractor is fastened to the top part of the center console and the belt receiver is fastened to a dashboard of the vehicle.

12. The vehicle of claim 9, wherein the belt receiver is fastened to the top part of the center console and the belt retractor is fastened to a dashboard of the vehicle.

13. The vehicle of claim 9, wherein the belt webbing is vertically, in a vertical direction of the vehicle, between the belt retractor and the belt receiver.

14. The vehicle of claim 13, wherein the belt receiver is fastened to the top part of the center console and the belt retractor is fastened to the bottom part of the center console.

15. The vehicle of claim 13, wherein the belt receiver is fastened to the bottom part of the center console and the belt retractor is fastened to the top part of the center console.

16. The vehicle of claim 9, wherein the top part of the center console is longitudinally displaceable with a front end of the top part as far as a dashboard of the vehicle in the longitudinal direction of the vehicle.
